(19) United States
(12) Patent Application Publication
(10) Pub. No.: US 2024/0204722 A1
(43) Pub. Date: Jun. 20, 2024

(54) HYBRID WATER SYSTEM FOR AGRO-PV SYSTEM

(71) Applicant: SOLARGIK LTD, JERUSALEM (IL)

(72) Inventors: Gil Kroyzer, Jerusalem (IL); Israel Kroizer, Jerusalem (IL); Morag Am Shallem, Jerusalem (IL); Joseph Schwarzbach, Jerusalem (IL)

(21) Appl. No.: 18/396,544

(22) Filed: Dec. 26, 2023

Related U.S. Application Data
(63) Continuation of application No. PCT/IB2023/062501, filed on Dec. 11, 2023.
(60) Provisional application No. 63/432,395, filed on Dec. 14, 2022.

(51) Int. Cl. H02S 40/44; A01G 25/02; H02S 40/10

(52) U.S. Cl. CPC H02S 40/44; A01G 25/02; H02S 40/10

(57) ABSTRACT

A solar energy collection system comprises an array of photovoltaic (PV) modules arranged to be pivoted about a longitudinal axis of the array by a drive system comprising an electric motor and a gearing arrangement, and a group of plants arranged to produce a crop. An irrigation system is configured to supply water to the group of plants in accordance with an irrigation program, and comprises a fluid conveyance that delivers at least some of the water to surfaces of the PV modules, which are disposed so that most of the delivered water entrains dirt on the surfaces of the PV modules and drips down to reach the plants. A controller configured to control the array of PV modules, wherein the controller is configured to orient the PV modules to a cleaning orientation prior or during delivery of the water.

### FIELD OF THE INVENTION

The present invention relates to hybrid solar energy systems for generating electricity by an array of photovoltaic (PV) assemblies and growing crops from plants disposed under and in proximity to the array, and in particular to hybridizing irrigation and PV-cleaning methods and systems using tracking systems arranged to pivot the PV assemblies.

### BACKGROUND

Achieving a diversified low-carbon emissions energy economy has been limited by economic and technological limitations. Solar energy systems comprising photovoltaic (PV) arrays are commonly deployed to capture energy from both direct and diffuse (including reflected) solar irradiance. Tracking PV systems are deployed in which PV arrays are pivoted to reduce the cosine losses of the direct irradiance component, so-called because the energy absorbed is a function of the cosine of the angle between the incidence vector and a normal vector of the PV array.

PV arrays serve to generate electricity when solar illumination is incident upon the arrays. Generated electricity is typically fed into an electrical grid of the city/locality.

The demand for solar electricity and shortage of suitable, available land have led to trying to install PV arrays where crops are grown, and even to integrate management of the PV panels with the agricultural enterprise. This leads to a need to control the allocation of water between the PV array and the plants, which both require the water—for generating electricity and growing crops, respectively. The naïve solutions are arbitrary and involve trial and error. There is a need for methods and systems which can optimize, over any appropriate time frame, the splitting of the water, e.g., based on a value function that takes into account the saleable value of the products (electricity and crops), the operational constraints of both the PV and the plants, and any other utility functions.

### SUMMARY

According to embodiments disclosed herein, a solar energy collection system comprises: (a) an array of photovoltaic (PV) modules arranged to be pivoted about a longitudinal axis of the array by a drive system comprising an electric motor and a gearing arrangement; (b) a group of plants arranged to produce a crop; and (c) an irrigation system configured to supply water to the group of plants in accordance with an irrigation plan or program. The irrigation system comprises a fluid conveyance disposed to deliver at least a portion of the water to respective surfaces of the PV modules, and the PV modules are disposed so that at least 50%, or at least 60%, or at least 70%, or at least 80%, or at least 90%, of the delivered water entrains dust and/or dirt on the respective surfaces of the PV modules, and drips therefrom to reach at least a subset of the plants. The solar energy collection system further comprises: (d) a controller configured to control the array of PV modules, wherein the controller is configured to orient the PV modules to a cleaning orientation prior or during delivery of the water.

In some embodiments, the controller can be configured to select the cleaning orientation based on a measure of cleaning efficacy. In some embodiments, the controller can be configured to select the cleaning orientation based on a dripped-water footprint. In some embodiments, the controller can be configured to change the selected cleaning orientation during the delivery of water so as to change the dripped-water footprint. In some embodiments, the controller can be configured to select different cleaning orientations for different deliveries of water so as to enable different dripped-water footprints.

In some embodiments, the cleaning orientation can be selected to optimize a dwell time of delivered water on the respective surfaces of the PV modules.

In some embodiments, the controller can be configured to perform an optimization of a water-usage value function based on a current state thereof, by dynamically selecting one or more cleaning orientations based on the optimization of the value function, and to control, based on the optimization of the value function, at least one of the PV modules to switch between a respective first orientation to a respective second orientation to increase a value of the current state. In some embodiments, the optimization of the value function can be based on at least one of a measure of cleaning efficacy and a dwell time of delivered water on the respective surfaces of the PV modules. In some embodiments, the optimization of the value function can be based on a dripped-water footprint at a cleaning orientation. In some embodiments, the optimization of a water-usage value function can also be by selecting a quantity of water to be delivered to the respective surfaces of the PV modules.

In some embodiments, the fluid conveyance can include a drip-irrigation device. In some embodiments, the fluid conveyance can include a spraying device.

In some embodiments, the fluid conveyance can additionally be configured to supply a further portion of water directly to the plants.

A method is disclosed, according to embodiments, for operating a solar energy collection system that comprises: (i) an array of photovoltaic (PV) modules arranged to be pivoted about a longitudinal axis of the array by a drive system comprising an electric motor and a gearing arrangement, (ii) group of plants arranged to produce a crop, and (iii) an irrigation system arranged to supply water to the group of plants, the irrigation system comprising a fluid conveyance disposed to deliver at least a portion of the water to respective surfaces of the PV modules. The method comprises: (a) supplying water to the group of plants in accordance with an irrigation plan or program; (b) delivering at least a portion of the water to respective surfaces of the PV modules; and (c) prior to or during delivery of the at least a portion of the water, orienting the PV modules to a cleaning orientation, so that at least 50%, or at least 60%, or at least 70%, or at least 80%, or at least 90%, of the delivered water entrains dust and/or dirt on the respective surfaces of the PV modules, and drips therefrom to reach at least a subset of the plants.

In some embodiments, the cleaning orientation can be selected based on a measure of cleaning efficacy. In some embodiments, the cleaning orientation can be selected based on a dripped-water footprint.

In some embodiments, the method can additionally comprise: reorienting the PV panels to a second cleaning configuration during the delivery of water so as to change the dripped-water footprint.

In some embodiments, the method can additionally comprise: orienting the PV panels to different cleaning orientations for different deliveries of water (multiple instances of delivering water) so as to enable different dripped-water footprints.

In some embodiments, the cleaning orientation can be selected to optimize a dwell time of delivered water on the respective surfaces of the PV modules.

In some embodiments, the method can additionally comprise: (i) performing an optimization of a water-usage value function based on a current state thereof, by dynamically selecting one or more cleaning orientations based on the optimization of the value function, and (ii) controlling, based on the optimization of the value function, at least one of the PV modules to switch between a respective first orientation to a respective second orientation to increase a value of the current state.

In some embodiments, the optimization of the value function can be based on at least one of a measure of cleaning efficacy and a dwell time of delivered water on the respective surfaces of the PV modules. In some embodiments, the optimization of the value function can be based on a dripped-water footprint at a cleaning orientation.

In some embodiments, the optimization of the value function can also be by selecting a quantity of water to be delivered to the respective surfaces of the PV modules.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 shows a block diagram of a photovoltaic (PV) energy collection system, according to embodiments of the present invention.

FIG. 2 shows a schematic layout of selected components of a PV energy system according to embodiments of the present invention.

FIG. 3 shows a block diagram of a controller for a solar energy collection system, according to embodiments of the present invention.

FIG. 4A is a schematic perspective partial view of a solar energy collection energy system according to embodiments of the present invention.

FIG. 4B shows a detail of the solar energy collection energy system of FIG. 4A in hybrid operation, according to embodiments of the present invention.

FIGS. 5A and 5B show schematic end views of a solar energy collection system comprising a PV array and a group of plants, wherein water is being delivered to PV panels which are oriented to drip water in respective dripped-water footprints, according to embodiments of the present invention.

FIGS. 6A shows a schematic end view of a solar energy collection system comprising a PV array and a group of plants, wherein water is being delivered to PV panels which are oriented to drip water in respective dripped-water footprints, and wherein additional water is supplied directly to plants not in the dripped-water footprint, according to embodiments of the present invention.

FIG. 6B shows a schematic end view of a solar energy collection system comprising a PV array and a group of plants, wherein water is being delivered to PV panels which are oriented to drip water in respective dripped-water footprints, according to embodiments of the present invention.

FIGS. 7A, 7B, 7C and 7D show flowcharts of methods and method steps for operating a solar energy collection system, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

The term ‘solar energy collection system’ as used herein means a system for producing electricity from PV modules and growing crops from plants that are at least partly shaded by the PV modules. A solar energy collection system includes: (i) a PV energy system for generating electricity using an array of PV modules, generally but not necessarily including an inverter for converting the direct-current (DC) electricity generated by the PV modules to alternating current (AC) electricity, e.g., for delivery to an electricity grid, and optionally an energy storage device for short-term or long-term storage of DC electricity for later conversion to AC and/or stabilization of the output of the PV system; and (2) a collection of plants for growing crops.

Embodiments disclosed herein relate to a hybridized, and optionally optimized, system for supplying water to plants for growing crops and delivering panel-cleaning water to arrays of PV modules for generating electricity. An optimizing includes maximizing a value function that gives weight to various aspects of the electricity generation and crop-growing in accordance with desired outcomes. Examples of desired outcomes can include, whether singly or in combination, and not exhaustively: maximized combined revenues from selling electricity and crops, maintaining plant health including long-term plant health, meeting contractual obligations for deliveries of electricity and/or crops, delivering electricity according to preferred times or days of delivery, extending the life of the components of the PV energy system, maximizing environmental contribution, e.g., reduction of net carbon dioxide or other emissions in comparison with alternative sources of electricity and/or plants, return on investment in the solar energy collection system, or any other financial indicators. In accordance with the desired outcomes, the value function can be based on values associated with and/or assigned to any number of parameters that can be used to measure progress relative to the desired outcomes. For example, the parameters can include, and not exhaustively: units of electricity generated and/or crops produced (and when generated or produced), revenue generated, adherence to a short- or long-term (including, e.g., multi-year) growing regime, adherence to an electricity delivery plan, contribution to environmental goals, e.g., plant mass grown for carbon dioxide absorption, and so on. Moreover, the optimal growing conditions of the selected plants are taken into account in the parameters of the value function, as not every type of plant maximizes crop value with the same irrigation program.

The value function has a current state that can be updated at any given time with, e.g., actual watering and cleaning data including information on how water has been used until the current time. The value function can generally be optimized on a going-forward basis, i.e., starting each time from the current state and extending into the future. The value function can be optimized over a time period that ends, e.g., at the end of a growing season, at the end of an accounting period such as a calendar year or fiscal year, or any other time period desired.

The PV modules of the PV energy system are pivotable by a motor assembly in communication with a control system, generally called a ‘controller’ in the disclosure, the controller generally being separate from a ‘charge controller’ of the PV energy system which directs DC electricity to and from the energy storage device. The terms ‘PV panels’, ‘PV modules’, and ‘PV assemblies’ are used interchangeably, and all relate to the active electricity-generating elements of PV assemblies.

The expression ‘based on’ as used throughout the disclosure means ‘at least partly based on’ and does not imply ‘exclusively based on’.

The pivoting of the PV modules relates to multiple types of operation. In ‘on-sun’ operation, the PV modules can be pivoted to an ‘on-sun’ position in which the active faces of the respective PV modules are normal, or close to normal, to the incoming radiation of the sun on at least one axis of rotation. This position tends to increase or maximize the incidence of the direct component of insolation on the PV modules by minimizing the cosine of the angle between the incident direct radiation and the normal vector of the active face of the PV module. On-sun operation includes incremental pivoting called ‘tracking’ so as to maintain the normal or near-normal on-sun position over time in accordance with the apparent movement of the sun across the sky due to the earth's rotation. In ‘off-sun’ operation, the PV modules are pivoted to and from other orientations that are not on-sun. Off-sun operation can be used for various purposes and in various scenarios, such as for stowing in a ‘safe’ position for protection from winds, or for cleaning the PV panels; in the embodiments disclosed herein, off-sun operation is commonly used to orient the PV modules in ‘cleaning orientations’, i.e., orientations selected for cleaning the PV modules.

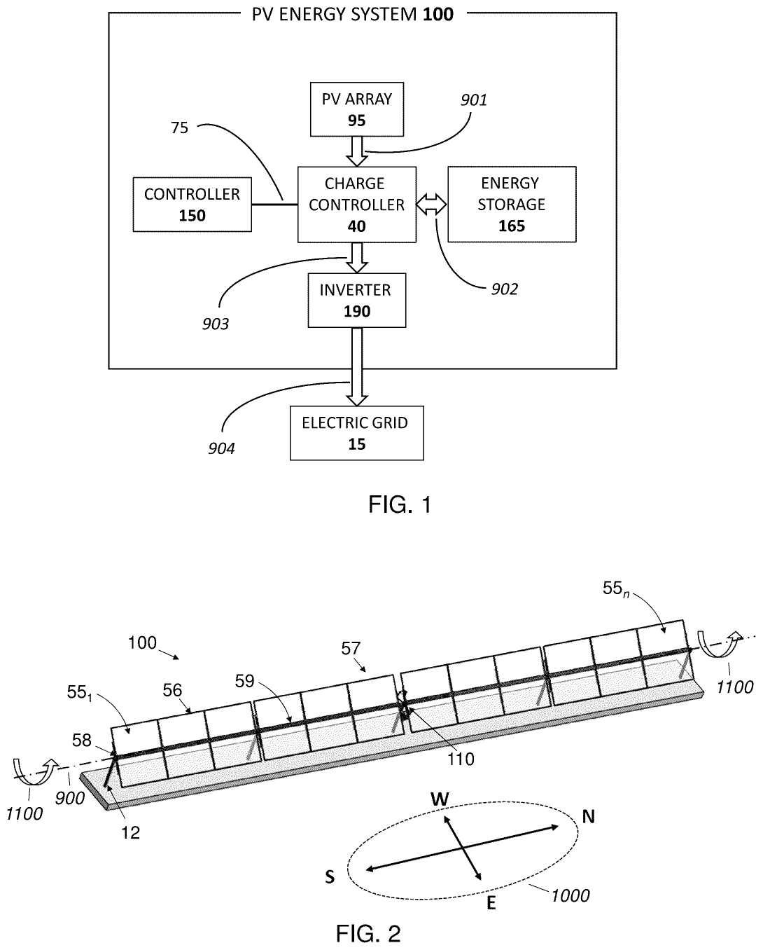

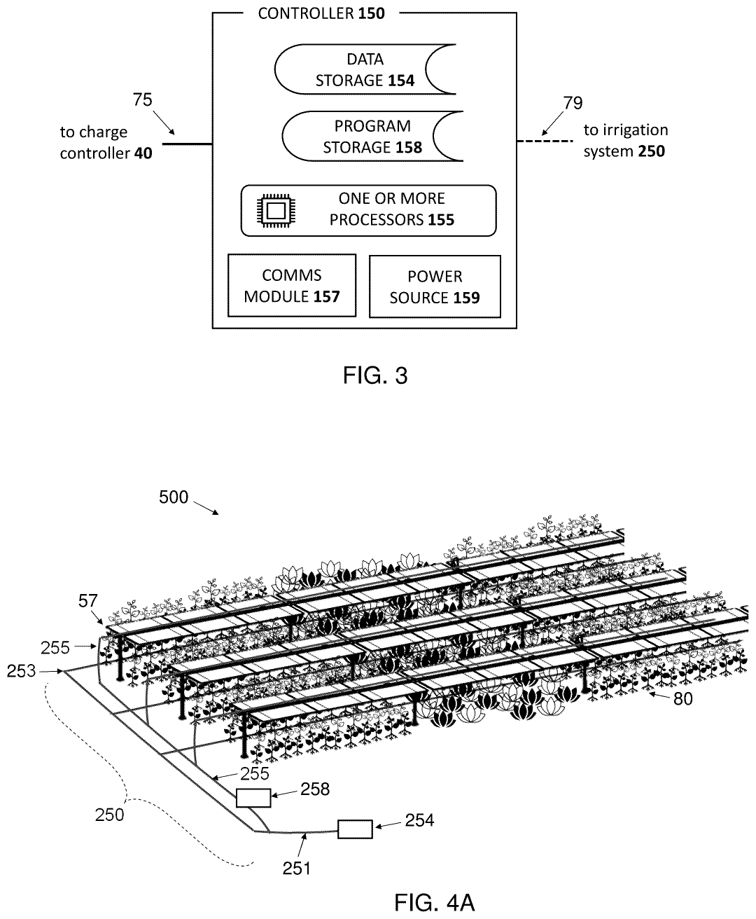

Referring now to the figures, and in particular to FIG. 1, a PV energy system 100 according to embodiments includes a PV array 95 comprising a plurality of PV modules 57 (shown in FIG. 2). In embodiments, the PV array 95 includes a tracking component, i.e., a solar tracker, for increasing cumulative electricity generated over the course of a period of time.

The solar tracker, or simply ‘tracker’, changes the orientation of the PV panels so as to capture, i.e., convert, a higher or lower proportion of the direct irradiance falling on the panels over the course of any given period of time. Capture and conversion of the diffuse radiation component is usually unaffected, e.g., within ±5% or within ±10% or within ±20%, by the tracking. A single-axis tracker is one that rotates PV panels around a single axis; tracking, whether on-sun or off-sun, is generally from east to west over the course of a day around a north-south axis. A double-axis tracker is designed to pivot in two axes, and is configured to pivot the PV panels to ‘face’ the sun directly and not just in a single plane, so as to absorb all available direct irradiance if desired. Some double-axis trackers operate using Euler angles and are not, strictly speaking, rotating the PV panels about two Cartesian axes, but the results are substantially the same. The embodiments disclosed herein are described throughout the specification in terms of single-axis tracking, but their application, mutatis mutandis, to double-axis tracking, is within the scope of the present invention.

The PV energy system 100 of FIG. 1 additionally includes an inverter 190 for conversion of DC electricity to AC. An inverter can include electronic circuitry, for example for synchronizing the phase, and for matching the voltage and frequency of the power output to those of the grid. The PV array typically has an output rating in kilowatts peak (kWp) which is the maximum DC power output rating for a given set of standard of environmental and operating conditions such as, e.g., temperature.

FIG. 1 further illustrates a non-limiting example of a power flow scheme for a PV energy system 100: power generated by the PV array 95 flows to a charge controller 40 as indicated by arrow 901. Two-way power flow takes place between the charge controller 40 and an energy storage device 165, as indicated by two-way arrow 902. Power from the PV array 95 and the energy storage device 165 flows through the charge controller 40 to the inverter 190, as indicated by arrow 903. The inverter 190 can deliver energy to the electric grid 15, as indicated by arrow 904.

Referring now to FIG. 2, a PV energy system 100 according to embodiments includes one or more PV modules 57. The PV module 57 includes an array of n PV panels 55₁ through 55ₙ, joined to a support subassembly 58. The support subassembly 58 includes an array of frames 56 for mounting the PV panels 55, and a central elongated member 59 to which the frames 56 are joined. The central elongated member 59 serves to transfer a torque to rotate the frames 56 as a unit together with the central elongated member 59 and the PV panels 55. The PV module 57 is rotated about a central longitudinal axis indicated in FIG. 2 by dashed line 900, and the rotation is schematically represented by arrows 1100. The central elongated member 59 is pivotably supported by ground supports 12. As shown by axes 1000, the panels are facing generally east, indicating that FIG. 2 shows a morning orientation. The tracking of the PV module 57 is shown as being east-west tracking as is the case in the vast majority of current installations of PV modules, but the principles disclosed here are equally applicable to north-south tracking systems, mutatis mutandis.

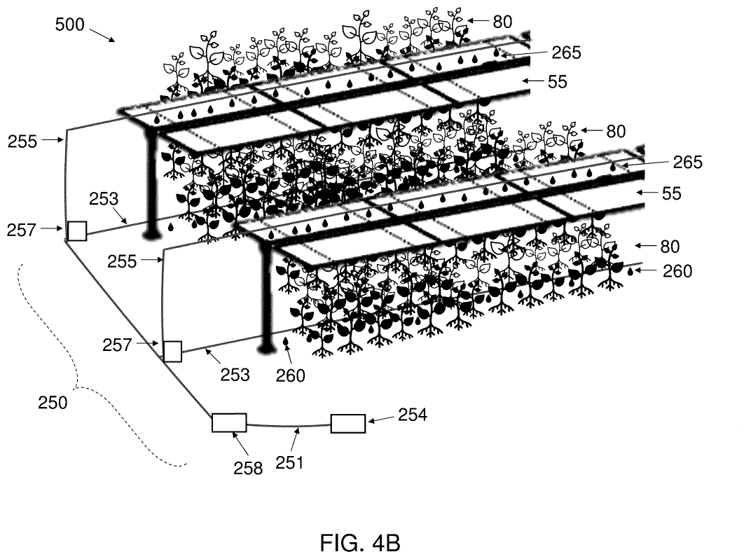

An exemplary controller 150 for a PV energy system 100, according to embodiments, is illustrated schematically in FIG. 3 to show selected components. The exemplary controller 150 includes one or more computer processors 155, a computer-readable storage medium 158, a communications module 157, and a power source 159. The computer-readable storage medium 158 can include transient and/or transient storage, and can include one or more storage units, all in accordance with desired functionality and design choices. The storage 158 can be used for any one or more of: storing program instructions, in firmware and/or software, for execution by the one or more processors 155 of the control system 150. In embodiments, the stored program instructions include program instructions for operating a PV energy system 100 and/or solar energy collection system 500, including for orienting PV panels 55 to cleaning orientations and for optimizing a value function. Data storage 154, if separate from storage 158, can be provided for historical data, e.g., actual irradiance and/or forecast values, e.g., forecasted irradiance values, and other data related to the operation of the solar energy collection system 100. In some embodiments, the two storage modules 154, 158 form a single module. The communications module 159 is configured to establish communications links, e.g., and not exhaustively, via communication arrangements 79 with an irrigation system 250 (described below), and with the charge controller 40 via communications arrangements 75. In some embodiments, a control system 150 does not necessarily include all of the components shown in FIG. 3. The terms “communications arrangements” or similar terms such as “communications links” as used herein mean any wired connection or wireless connection via which data communications can take place. Non-limiting and non-exhaustive examples of suitable technologies for providing communications arrangements include any short-range point-to-point communication system such as IrDA, RFID (Radio Frequency Identification), TransferJet, Wireless USB, DSRC (Dedicated Short Range Communications), or Near Field Communication; wireless networks (including sensor networks) such as: ZigBee, EnOcean; Wi-fi, Bluetooth, TransferJet, or Ultra-wideband; and wired communications bus technologies such as CAN bus (Controller Area Network, Fieldbus, Fire Wire, HyperTransport and InfiniBand.

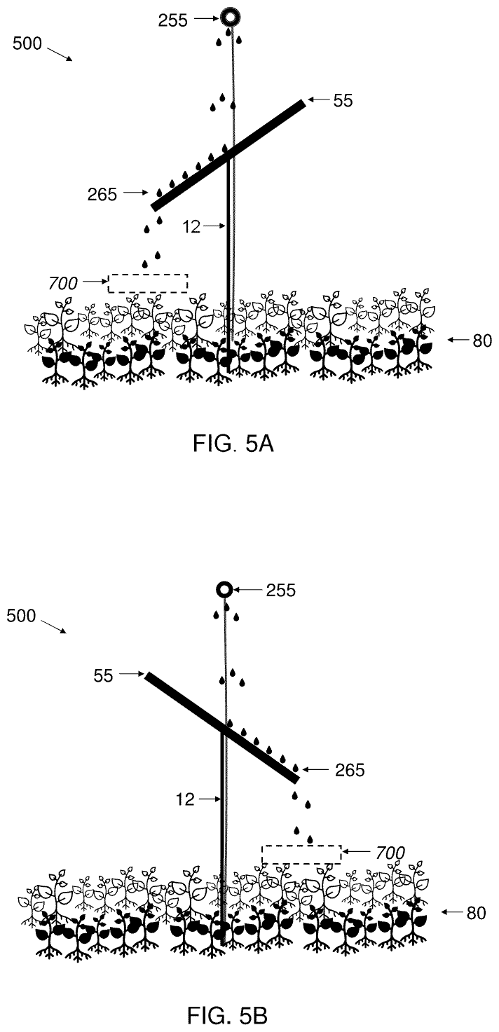

FIG. 4A and 4B are respective schematic illustrations of exemplary solar energy collection systems 500 according to embodiments. A solar energy collection system 500 includes an array of PV modules 57 which comprise, as shown in FIG. 2, frames 56 for mounting PV panels 55 and thereby connecting the panels 55 to the elongated torque transfer member 59 and the drive system 110. The drive system 110 includes a motor assembly directly controlled by the controller 150, and gearing arrangements for efficient pivoting of the PV array to orient the panels in selected orientations, both on-sun orientations and off-sun orientations such as for cleaning.

The solar energy collection system 500 also includes one or more groups of plants 80 that require exposure to solar radiation and water from an irrigation system 250 to grow crops therefrom. The term ‘crops’ is used broadly herein, and can mean any part of the plant with economic value when harvested and sold, and/or environmental value for absorption of carbon dioxide and/or soil retention. The plants can produce crops annually, or more frequently, or less frequently. In one example, the plants can produce crops over several growing seasons and then be prevented from producing crops for one or more growing seasons. The preventing can include any combination of causing a reduction in water or available solar energy and mechanically and/or chemically modifying the plants.

The solar energy collection system as disclosed herein includes an irrigation system configured to supply water to the group of plants in accordance with an irrigation plan or program. The irrigation system includes a variety of pipes and/or hoses spread throughout the solar energy collection system, and can be configured to employ any combination of drip irrigation techniques and/or spray irrigation techniques. In embodiments, the irrigation system comprises one or more fluid conveyances, e.g., hoses and/or pipes arranged to deliver at least a portion of the irrigation water to respective surfaces of the PV modules for cleaning. The surfaces of the PV modules are typically soiled by dirt, e.g., dust and/or various residues and organic contaminants. The intensity, duration and frequency of cleaning the surfaces of the PV panels are determined by any one or more of a number of factors, including, and note exhaustively: local soiling characteristics, the economics of losing electricity generation to soiling, and the cost of cleaning, including the cost of water and especially cleaning water treated to remove dissolved solids. In some embodiments, the PV panels are periodically brushed or scrubbed to remove dirt, either manually or by machine, but in some such embodiments, running water over the surfaces of the panels can help reduce the frequency of the brushing or scrubbing and thereby reduce operating costs. At appropriate orientations, least 70%, or at least 80%, or at least 90%, of the water delivered to PV modules entrains dust and/or dirt from the surfaces and drips down onto the plants to reach at least some of them, e.g., within a dripped-water footprint. The cleaning orientation can be selected at any time(s) before or during a cleaning session, e.g., by a controller, on the basis of any one or more of a number of factors, including a measure of cleaning efficacy, dwell time on the surface of the modules, and dripped-water footprint.

In some implementations of the embodiments, water for washing or cleaning the PV panels undergoes treatment to reduce, i.e., partially remove, dissolved solids which can adversely affect electrical output of PV panels after cleaning water evaporates and leaves the solids behind. The dissolved solids can include salts and other minerals, as well as dissolved organic solids. In some embodiments, the amount of dissolved solids in the cleaning water can be limited to less than 200 mg/L (milligrams per liter), or less than 150 mg/L, or less than 100 mg/L, or less than 75 mg/L, or less than 50 mg/l. Exemplary configurations of an irrigation system for a solar energy collection system according to embodiments include, and non-exhaustively:
1. providing a water treatment facility only for the water that is delivered to the PV panels but not for the water that is supplied directly to the plants;
2. providing a water treatment facility for all water used, whether for cleaning PV panels or for supply to the plants; and
3. supplying water from a source of ‘soft water’, i.e., water that meets the dissolved-solids requirements for PV panel cleaning without any further on-site treatment.

FIG. 4A illustrates a first non-limiting example of an irrigation system 250 according to the first configuration of the foregoing list of exemplary configurations. Water from source 254, e.g., a reservoir, water tank, well, municipal supply, etc., is piped through intake pipe 251. A portion of the water is routed through treatment facility 258 and is further routed through hoses 255 (or, equivalently, pipes or tubes) to the soiled surfaces of the PV panels. After the branching off to the treatment facility 258, untreated water, i.e., water not treated locally, is supplied to a network of direct-irrigation pipes 253 laid out in accordance with irrigation needs; FIG. 4A shows a typical layout in which direct-irrigation pipes 253 follow individual rows of plants 80. Other irrigation techniques may require different layouts, e.g., a smaller number of pipes 254 each of which covers a larger area. The irrigation system includes one or more cleaning-water delivery hoses 255, or, equivalently, pipes or tubes, which deliver a portion of the irrigation water directly to the soiled upper surfaces of the PV modules 57. An irrigation plan or program is carried out by one or more irrigation controllers (not shown in FIGS. 4A) which determine how much water is delivered by each set of pipes 253, 255 and when.

FIG. 4B shows a second non-limiting example of an irrigation system 250, in this case configured in accordance with the second configuration of the foregoing list of exemplary configurations. Water from source 254, e.g., a reservoir, tank, municipal supply, etc., is piped through intake pipe 251 to water treatment facility 258. From there the water supply continues through pipes/hoses 253 of the plant-irrigation system via remotely controllable junctions 257 configured to route water through sub-networks or rows of plant-irrigation pipes 253 and/or through sub-networks of cleaning-water pipes 255 in response to local programming and/or in response to instructions received from one or more central irrigation controllers (not shown). Panel-cleaning water 265 delivered by the cleaning water pipes 255 is shown dripping onto the surfaces of the PV panels 55, while plant-irrigation water 260 supplied by the plant-irrigation pipes 253 is shown dripping onto the plants and/or on the soil beneath and/or around the plants. While FIG. 4B shows both systems (the PV cleaning-water system and the plant-irrigation system) as both being active simultaneously, this is merely for illustration, and in other conditions (not illustrated) either one or the other of the two systems can be operated individually. The skilled artisan will understand that removal or bypassing of the water-treatment facility 258 places the irrigation system 250 in the third configuration of the foregoing list of exemplary configurations.

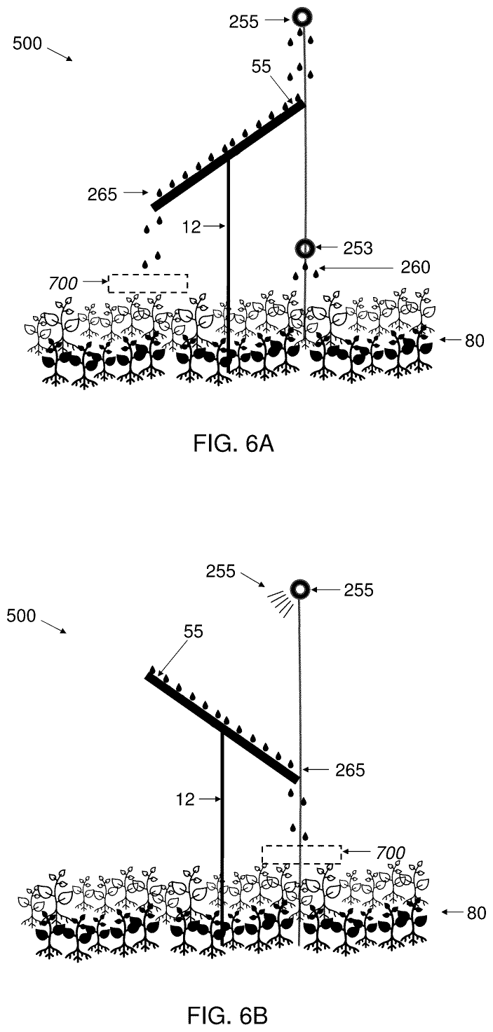

FIGS. 5A and 5B schematically illustrate the delivering of cleaning water to the respective sun-facing surfaces of PV panels 55 in a manner that facilitates the second use of the cleaning water 265 to irrigate crops 80, in a first exemplary water-delivery configuration in which the cleaning-water delivery pipe 255 is disposed over the longitudinal center of the array of PV modules 57. Shown as end views, i.e., as viewed from the end of a row, FIGS. 5A and 5B show a cleaning-water delivery pipe 255 dripping water 265 onto the PV panels 55, such that the water 265 drips onto the plants 80 within a dripped-water footprint 700 determined mostly by the orientation of the panels 55 (also determined, to a lesser extent, by wind and other minor factors). The water 265 entrains dirt and dust resident on the surfaces of the PV panels 55 such that the dirt and dust are removed from the panels and dripped with the cleaning water 265 onto the plants 80. In the exemplary configuration of FIGS. 5A and 5B, the cleaning water 265 is delivered to the panels 55 from a pipe 255 running lengthwise along a centerline of the panels 55, such that two different cleaning orientations of the panels 55 are necessary for cleaning the entire panel. The two different orientations, i.e., the left-facing orientation of FIG. 5A and the right-facing orientation of FIG. 5B, can be selected in one delivery of cleaning water 265, or in multiple deliveries; for example, the orientation of FIG. 5A shortly after sunset and the orientation of FIG. 5B shortly before sunrise, or, alternatively, the orientation of FIG. 5A on one day and the orientation of FIG. 5B on a different day.

In embodiments, each orientation creates a specific dripped-water footprint 700. It can therefore be desirable to select cleaning orientations of the PV panels 55 based on a resultant predicted dripped-water footprint 700. It can be desirable to change the selected cleaning orientations during a single delivery of cleaning water 265 or between deliveries of cleaning water 265. In a non-limiting example, 10 different cleaning orientations are selected during 30 minutes of cleaning-water delivery, in a manner that the resultant dripped-water footprints cover a maximum are of plants 80. In another non-limiting example, the PV panels 55 are reoriented every 10 to 20 seconds during a delivery of cleaning water, or every 20 to 40 seconds, or every 40 to 90 second, or every 90 to 300 seconds, or less frequently.

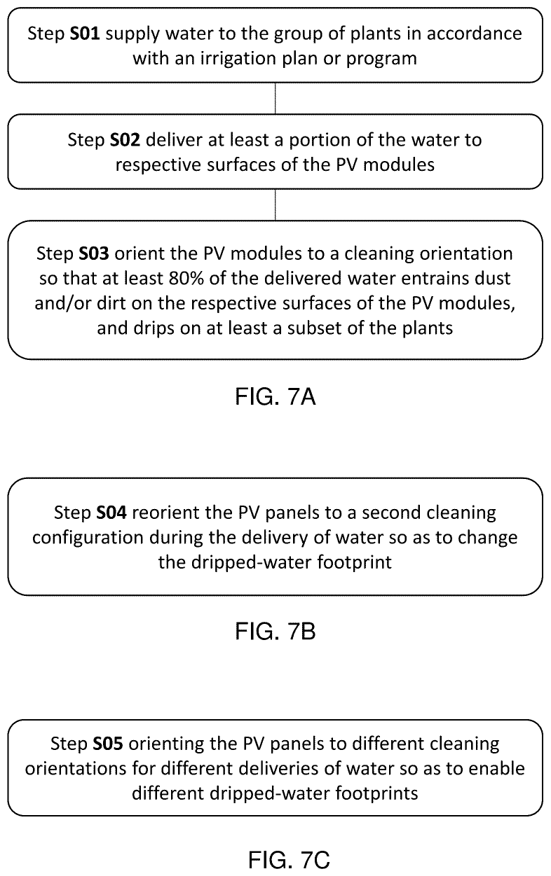

FIGS. 6A and 6B also schematically illustrate the delivering of cleaning water to the respective sun-facing surfaces of PV panels 55 in a manner that facilitates the second use of the cleaning water 265 to irrigate crops 80, in a second exemplary water-delivery configuration in which the cleaning-water delivery pipe 255 is not disposed over the longitudinal center of the array of PV modules 57. FIG. 6A shows an illustrative configuration in which the dripped-water footprint 700 is all to one side of the group of plants 80. On the other side (the right side of FIG. 6B), the plants 80 are watered directly by a direct-irrigation pipe 253. FIG. 6B shows another illustrative configuration in which the cleaning-water delivery pipe 255 uses a spray-irrigation technique to reach the PV panels 55 while oriented to drip cleaning water 265 in a dripped-water footprint 700 on the right side of the figure. When alternatively oriented in the cleaning orientation of FIG. 6A, the same PV panels 55 drip to the left side as shown in FIG. 6A. This can entail switching between spraying and dripping depending on the cleaning orientations selected. Any of the embodiments described herein can use any combination of drip-irrigation techniques and spray-irrigation techniques.

In some embodiments, the controller 150 of the solar energy collection system 500 is configured, e.g., programmed, to perform an optimization of a value function based on a current state, by dynamically determining one or more cleaning orientations for the array of PV modules. Changing a cleaning orientation is effective to change the cleaning efficacy of PV modules 57, and affects the distribution of water directed to irrigation of the plants. The predicted results, e.g., reduced soiling losses, distribution of dripped-water footprints, etc., are used as a basis for performing the optimization.

In embodiments, a suitable value function can have the following general form: ∫ₜ_{₀}^{t}^{ₙ}(NET_VALUE_ADDED_{PV}+NET_VALUE_ADDED_{PLANTS})+STATEₜ_{₀} wherein the optimization of the value function at time=t₀ is a maximization of the function over the future time period from time=t₀ to time=tₙ. When the optimization is is performed, t₀ can be set to the current time. Time=tₙ, may reflect the end of a growing season; the end of an accounting period, e.g., a year; the end of a time period with a preferential tariff for electricity selling prices; the end of a time period with a preferential price structure for selling crops produced by the plants 80, e.g., strawberries in winter; the end of a multi-year cycle of a multi-year growing regime, or any other desirable interval end.

The value function incorporates desired outcomes with respect to electricity generation and crop-growing in a mathematical expression, either as incremental arithmetic inputs, or as system inputs or constraints. Illustrative examples of possible arithmetic inputs include, and not exhaustively: unit sales price of electricity at the time of generation; market value of crops grown in accordance with a growing schedule (and incremental or decremental value accruable to deviations from the growing plan); and amount of carbon dioxide absorbed by plant mass through photosynthesis. Illustrative examples of system inputs and constraints include, and not exhaustively: lifecycle cost of generating electricity; minimum and maximum sales obligations of both electricity and crops; multi-season growing regimes that include or de-emphasize non-cultivation in some seasons; time remaining in the optimization interval from time=t₀ to time=tₙ; and future market information on demand for electricity and/or crops. In some embodiments, the optimization of the value function includes maximizing a revenue stream. In some embodiments, the optimization of the value function includes maximizing an indirect utility function, e.g., a societal or environmental utility function.

For assessing values of the function, all inputs and constraints are assigned numeric values, both positive and negative as appropriate, in a manner that drives the optimization of the value function to meet the desired outcomes to the extent allowed by externalities such as, e.g., actual insolation over the full optimization interval. Numeric values need not be one-dimensional, and the value function or any of its components can be based on a matrix of parameter values that can eventually be combined in a function made accessible to the user for changing preferences.

Each of NET_VALUE_ADDED_{PV} and NET_VALUE_ADDED_{PLANTS} represents an incremental contribution, whether positive or negative, to the value function. Even if, for example, a dynamic determination of cleaning orientation results in lower revenue for a given time period, the determination of cleaning orientation is based on maximizing the value function over the chosen time interval and not necessarily on maximizing a short-term gain.

In embodiments, the ratio of PV area to plant area does not affect the optimization of the value function,, and the determining of cleaning orientations, although such a ratio may affect the respective weightings given to the components (PV and plants) in the make-up of the value function. In some embodiments, the total surface area of the PV panels 55 can equal at least 10%, or at least 20%, or at least 30%, or at least 40%, or a higher proportion, of the area occupied by the plants 80. In some embodiments, the total surface area of the PV panels 55 can equal less than 10%, or less than 5%, or less than 2%, or less than 1% of the area occupied by the plants.

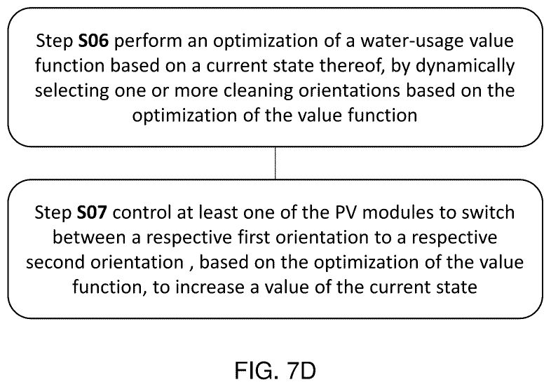

Referring now to FIG. 7A, a method is disclosed for operating a solar energy collection system 500, e.g., any of the solar energy systems 500 disclosed herein. According to the method, the solar energy collection system 500 comprises an array of PV modules 57 arranged to be pivoted about a longitudinal axis of the array by a drive system 110 comprising an electric motor and a gearing arrangement, a group of plants 80 arranged to produce a crop, and an irrigation system 250 arranged to supply water to the group of plants 80, the irrigation system 250 comprising a fluid conveyance 255 disposed to deliver at least a portion 265 of the water to respective surfaces of the PV modules 57. As illustrated by the flow chart in FIG. 7A, the method comprises at least the three method steps S01, S02, and S03.

Step S01 includes supplying water 260 to the group of plants 80 in accordance with an irrigation plan or program.

Step S02 includes delivering at least a portion 265 of the water to respective surfaces of the PV modules 57. In embodiments, Step S02 is carried out in parallel with Step S01. In some embodiments, Step S02 is not carried out every time that Step S01 is carried out.

Step S03 includes orienting the PV modules 57 to a cleaning orientation prior to or during delivery of the at least a portion of the water 265, so that at least 70%, or at least 80%, or at least 90%, of the delivered water 265 entrains dust and/or dirt on the respective surfaces of the PV modules 57 and drips therefrom to reach at least a subset of the plants 80. In some embodiments, the cleaning orientation is selected based on a measure of cleaning efficacy, e.g., in removal of dust, dirt, grime, and/or organic contaminants. In some embodiments, the cleaning orientation is selected based on a predicted or calculated dripped-water footprint 700. In some embodiments, the cleaning orientation is selected to optimize a dwell time of delivered water 265 on the respective surfaces of the PV modules 57.

In some embodiments, the method additionally comprises method step S04, as illustrated by the flow chart in FIG. 7B.

Step S04 includes reorienting the PV panels 57 to a second cleaning configuration during the delivery of water 265 so as to change the dripped-water footprint 700.

In some embodiments, the method additionally comprises method step S05, as illustrated by the flow chart in FIG. 7C.

Step S05 includes orienting the PV panels to different cleaning orientations for different deliveries of water 265, i.e., separate performances of Step S02, so as to enable different dripped-water footprints each time.

In some embodiments, the method additionally comprises method steps S06 and S07, as illustrated by the flow chart in FIG. 7D.

Step S06 includes performing an optimization of a water-usage value function based on a current state thereof, by dynamically selecting one or more cleaning orientations based on the optimization of the value function. The water-usage function can be, for example the water-usage function described earlier in connection with the function of A controller 150 of a solar energy collection system 500. In some embodiments, the optimization of the value function is based on at least one of a measure of cleaning efficacy and a dwell time of delivered water on the respective surfaces of the PV modules. In some embodiments, the optimization of the value function is based on a dripped-water footprint at a cleaning orientation. In some embodiments, the optimization of the value function is also by selecting a quantity of water to be delivered to the respective surfaces of the PV modules.

Step S07 includes controlling, based on the optimization of the value function of Step S06, at least one of the PV modules to 57 switch between a respective first orientation to a respective second orientation to increase a value of the current state.

In embodiments, some or all of the steps of the method can be carried out by a control system 150 of the PV energy system 100, e.g., the control system 150 of FIG. 3. In some embodiments, not all of the steps are necessarily performed.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A solar energy collection system comprising:
a. an array of photovoltaic (PV) modules arranged to be pivoted about a longitudinal axis of the array by a drive system comprising an electric motor and a gearing arrangement;
b. a group of plants arranged to produce a crop;
c. an irrigation system configured to supply water to the group of plants in accordance with an irrigation plan or program, wherein:
i. the irrigation system comprises a fluid conveyance disposed to deliver at least a portion of the water to respective surfaces of the PV modules, and
ii. the PV modules are disposed so that at least 50% of the delivered water entrains dust and/or dirt on the respective surfaces of the PV modules, and drips therefrom to reach at least a subset of the plants; and
d. a controller configured to control the array of PV modules, wherein the controller is configured to orient the PV modules to a cleaning orientation prior or during delivery of the water.

2. The solar energy collection system of claim 1, wherein at least 60%, or at least 70%, or at least 80%, or at least 90%, of the delivered water entrains dust and/or dirt on the respective surfaces of the PV modules, and drips therefrom to reach at least a subset of the plants

3. The solar energy collection system of claim 1, wherein the controller is configured to select the cleaning orientation based on a measure of cleaning efficacy.

4. The solar energy collection system claim 1, wherein the controller is configured to select the cleaning orientation based on a dripped-water footprint.

5. The solar energy collection system of claim 4, wherein the controller is configured to change the selected cleaning orientation during the delivery of water so as to change the dripped-water footprint.

6. The solar energy collection system of claim 4, wherein the controller is configured to select different cleaning orientations for different deliveries of water so as to enable different dripped-water footprints.

7. The solar energy collection system claim 1, wherein the cleaning orientation is selected to optimize a dwell time of delivered water on the respective surfaces of the PV modules.

8. The solar energy collection system of claim 1, wherein the controller is configured to perform an optimization of a water-usage value function based on a current state thereof, by dynamically selecting one or more cleaning orientations based on the optimization of the value function, and to control, based on the optimization of the value function, at least one of the PV modules to switch between a respective first orientation to a respective second orientation to increase a value of the current state.

9. The solar energy collection system of claim 8, wherein the optimization of the value function is based on at least one of a measure of cleaning efficacy and a dwell time of delivered water on the respective surfaces of the PV modules.

10. The solar energy collection system of claim 8, wherein the optimization of the value function is based on a dripped-water footprint at a cleaning orientation.

11. The solar energy collection system of claim 8, wherein the optimization of a water-usage value function is also by selecting a quantity of water to be delivered to the respective surfaces of the PV modules.

12. The solar energy collection system of claim 1, wherein the fluid conveyance includes a drip-irrigation device.

13. The solar energy collection system claim 1, wherein the fluid conveyance includes a spraying device.

14. The solar energy collection system of claim 1, wherein the fluid conveyance is additionally configured to supply a further portion of water directly to the plants.

15. A method of operating a solar energy collection system, the solar energy collection system comprising: (i) an array of photovoltaic (PV) modules arranged to be pivoted about a longitudinal axis of the array by a drive system comprising an electric motor and a gearing arrangement, (ii) group of plants arranged to produce a crop, and (iii) an irrigation system arranged to supply water to the group of plants, the irrigation system comprising a fluid conveyance disposed to deliver at least a portion of the water to respective surfaces of the PV modules, the method comprising:
a. supplying water to the group of plants in accordance with an irrigation plan or program;
b. delivering at least a portion of the water to respective surfaces of the PV modules; and
c. prior to or during delivery of the at least a portion of the water, orienting the PV modules to a cleaning orientation, so that at least 50% of the delivered water entrains dust and/or dirt on the respective surfaces of the PV modules, and drips therefrom to reach at least a subset of the plants.

16. The method of claim 15, wherein the cleaning orientation is such that at least 60%, or at least 70%, or at least 80%, or at least 90%, of the delivered water entrains dust and/or dirt on the respective surfaces of the PV modules, and drips therefrom to reach at least a subset of the plants.

17. The method of claim 15, wherein the cleaning orientation is selected based on a measure of cleaning efficacy.

18. The method of claim 15, wherein the cleaning orientation is selected based on a dripped-water footprint.

19. The method of claim 18, additionally comprising: reorienting the PV panels to a second cleaning configuration during the delivery of water so as to change the dripped-water footprint.

20. The method of claim 18, additionally comprising: orienting the PV panels to different cleaning orientations for different deliveries of water so as to enable different dripped-water footprints.

21-25. (canceled)
